(19) United States
(12) Patent Application Publication
(10) Pub. No.: US 2025/0051946 A1
(43) Pub. Date: Feb. 13, 2025

(54) ELECTROLYSIS APPARATUS FOR THE PRODUCTION OF IRON WITH AN IMPROVED GAS PERMEABLE ANODE PLATE

(71) Applicants: ArcelorMittal, Luxembourg (LU); John Cockerill, Seraing (BE)

(72) Inventors: Hervé LAVELAINE DE MAUBEUGE, Metz (FR); Luc VAN HEE, Oisy-Le-Verger (FR); Cédric FLANDRE, Liege (BE)

(21) Appl. No.: 18/719,823

(22) PCT Filed: Dec. 14, 2022
(86) PCT No.: PCT/IB2022/062222

§ 371 Date: Jun. 13, 2024

(30) Foreign Application Priority Data
Dec. 15, 2021 (WO) PCT/IB2021/061763

(51) Int. Cl. C25C 1/06; C25C 7/02; C25C 7/06

(52) U.S. Cl. CPC C25C 1/06; C25C 7/02; C25C 7/06

(57) ABSTRACT

An electrolysis apparatus for the production of iron through reduction of iron ore by an electrolysis reaction, the electrolysis reaction emitting a gas, the apparatus including a casing. The casing including a gas permeable anode plate being made of a cellular material, a cathode plate, both facing each other and being separated by an electrolyte chamber.

The present disclosure is related to an apparatus to produce iron by an electrolysis process.

### BACKGROUND

Steel can be currently produced at an industrial scale through two main manufacturing routes. Nowadays, most commonly used production route consists in producing pig iron in a blast furnace, by use of a reducing agent, mainly coke, to reduce iron oxides. In this method, approx. 450 to 600 kg of coke, is consumed per metric ton of pig iron; this method, both in the production of coke from coal in a coking plant and in the production of the pig iron, releases significant quantities of CO₂.

The second main route involves so-called “direct reduction methods”. Among them are methods according to the brands MIDREX, FINMET, ENERGIRON/HYL, COREX, FINEX etc., in which sponge iron is produced in the form of HDRI (Hot Direct Reduced Iron), CDRI (cold direct reduced iron), or HBI (hot briquetted iron) from the direct reduction of iron oxide carriers. Sponge iron in the form of HDRI, CDRI, and HBI usually undergo further processing in electric arc furnaces. Even if this second route emits less CO₂ than the previous one it still releases some and rely moreover on carbon fossil fuels.

Current developments thus focus on methods allowing to produce iron which release less or even no CO₂ and which is carbon-neutral.

A known alternative method to produce steel from iron ores is based on electrochemical techniques. In such techniques, iron is produced from iron oxide using an electrolyser unit comprising two electrodes—an anode and a cathode—connected to a source of electric current, an electrolyte circuit and an iron oxide entry into the electrolyser unit. The anode and cathode are constantly immersed in the circulating electrolyte in order to ensure good electrical conduction between said electrodes. The electrolytic reaction produces pure iron plates at the cathode and gaseous oxygen at the anode. Iron plates thus obtained may be then melted with other elements such carbon-bearing materials and/or as scrap in electrical furnaces to produce steel.

One of the problems of existing electrolysis cells is the gas accumulation. Indeed, gases formed by the electrolysis reactions tend to remain trapped between the anode and the cathode where they accumulate. Gaseous oxygen being an electrical insulator, it has a detrimental effect on the electrical conduction between the electrodes and thus on the productivity of the cell. One solution would be to have a continuous extraction of the electrolyte containing said gases, but this would mean a constant supply of fresh electrolyte which would also be detrimental to the productivity and to the environmental footprint of the process.

Another solution is to have a permeable anode allowing the electrolyte to pass through, thus drawing the gases out of the space between the anode and the cathode. However, the permeability has to be controlled in order to be able to evacuate continuously the gases without disturbing the electrolysis reaction. An aim of the present disclosure is therefore to remedy the drawbacks of the prior art by providing a gas permeable anode ensuring an improved extraction of the gases formed by the electrolysis reactions. One of the aims of the present disclosure is also to provide an anode which is easy to manufacture and cost effective.

### SUMMARY

For this purpose, the apparatus of the present disclosure comprises a casing including a anode plate, a cathode plate, both facing each other and being separated by an electrolyte chamber, said casing being provided with means for circulating an electrolyte within the electrolyte chamber and with means to supply iron ore to said electrolyte chamber, the casing further including a degassing unit comprising a gas recovery part extending along the opposite side of the gas permeable anode plate to the chamber and being able to recover gas from the electrolysis reaction escaping through the gas-permeable anode plate. According to the invention, said gas permeable anode plate is made of a cellular material comprising a plurality of cells extending from the electrolyte flowing chamber to the gas recovery part, each cell being delimited by a circumferential wall and being open on the two opposite sides of the gas permeable anode plate.

The apparatus of the present disclosure may also include the following optional characteristics considered individually or according to all possible combination of techniques:
the cells are regularly and periodically repeated on the gas permeable anode plate.
the circumferential wall of each cell has a hexagonal cross section.
two adjacent cells share one straight wall of their respective hexagonal circumferential wall.
the hexagon formed by the hexagonal circumferential wall of each cell is an equilateral hexagon.
the equilateral hexagon is defined according to the formula e/h<0.1, e being the thickness of the hexagonal wall and h being the distance between two opposite parallel straight walls of the hexagon.
the cellular material forming the gas permeable anode plate has a honeycomb structure.
the cellular material of the gas permeable anode plate is produced by welding a plurality of corrugated sheets to each other.
the casing comprises a cover plate facing the gas permeable anode plate, and the gas permeable anode plate comprises at least one T-shape groove extending transversally along the opposite side of the gas permeable anode plate to the chamber and receiving a corresponding T-shape rod. Fastening means cross the cover plate up to the T-shape rod thus maintaining the gas permeable anode plate at the required distance from the cathode plate.
the gas permeable anode plate is made of nickel alloy.

### BRIEF SUMMARY OF THE DRAWINGS

Other characteristics and advantages of the present disclosure will be apparent in the below descriptions, by way of indication and in no way limiting, and referring to the annexed figures among which:

FIG. 1, which represents a longitudinal section view of an apparatus according to the present disclosure,

FIG. 2, which represents a perspective view of the cellular material constituting the anode plate,

FIG. 3, which represents a top view of the cellular material of FIG. 2,

FIG. 4, which represents one block made of the cellular material of FIG. 2, the anode plate being made of a plurality of such blocks.

FIG. 5, which represents a longitudinal section view of part of the casing of the present disclosure illustrating the fastening means of the anode plate in the casing.

FIG. 6, which represents the main production steps of one block of cellular material.

### DETAILED DESCRIPTION

First, it is noted that on the figures, the same references designate the same elements regardless of the figure on which they feature and regardless of the form of these elements. Similarly, should elements not be specifically referenced on one of the figures, their references may be easily found by referring oneself to another figure.

It is also noted that the figures represent mainly one embodiment of the object of the present disclosure but other embodiments which correspond to the definition of the present disclosure may exist.

Elements in the figures are illustration and may not have been drawn to scale.

The present disclosure refers to an apparatus 1 provided for the production of iron metal (Fe) through the reduction of iron ore, containing notably hematite (Fe₂O₃) and other iron oxides or hydroxides, by an electrolysis reaction. Said chemical reaction is well known and may be described by the following equation (1):

$${Fe}_{2} {O}_{3} ↔ 2 Fe + \frac{3}{2} {O}_{2} \qquad ( 1 )$$

It thus appears that the electrolysis reaction emits gases—mainly oxygen—that must be extracted from the apparatus 1.

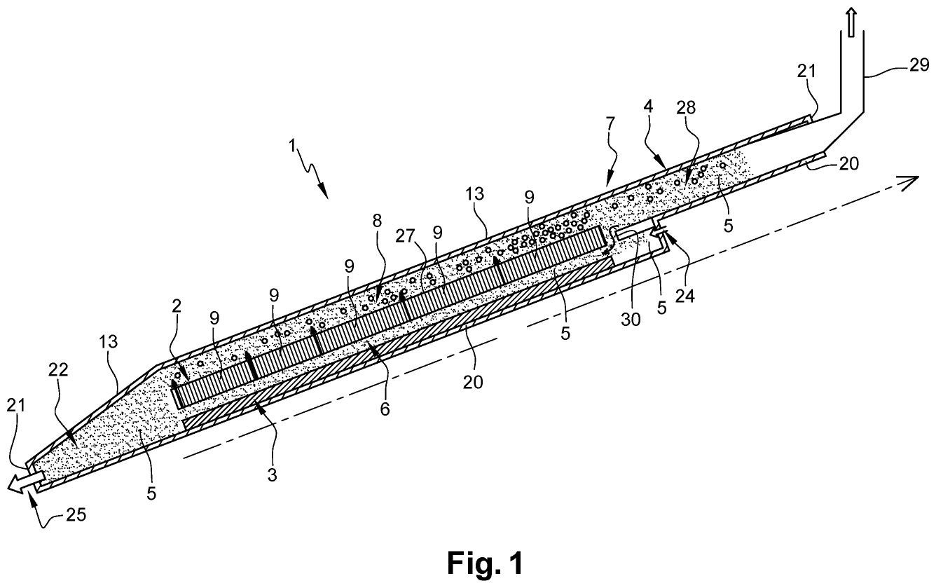

With reference to FIG. 1, the apparatus 1 comprises a casing 4 extending along a longitudinal axis X in which the electrolysis reaction occurs. Said casing 4 is delimited by a base plate 20, a cover plate 13 and two lateral plates 21. In addition, the casing 4 includes a gas permeable anode plate 2 intended to be totally immersed in an electrolyte 5 and a cathode plate 3, both plates facing each other and being kept at required distance with fastening means (no depicted in this figure). The casing 4 also includes an electrolyte chamber 6 extending longitudinally between the anode plate 2 and the cathode plate 3 up to an evacuation chamber 22. The apparatus 1 finally comprises an electrical power source (not depicted) connected to the anode plate 2 and the cathode plate 3.

In order to produce iron through the electrolysis reaction, the electrolyte 5—preferably a water-based solution like a sodium hydroxide aqueous solution—flows through the casing 4 inside the electrolyte chamber 6 while the apparatus 1 is operating. The apparatus 1 thus comprises means for circulating the electrolyte which may comprise an electrolyte circuit (not depicted) connected to an inlet 24 and an outlet 25 managed in the casing 4 and both fluidically connected to the electrolyte chamber 6. Iron ore is preferentially introduced into the apparatus 1 as a powder suspension within the electrolyte 5 through the inlet 24.

During the electrolysis reaction, oxidised iron is reduced to iron according to reaction (1) and reduced iron is deposited on the cathode plate 3 while gaseous oxygen is emitted inside the casing 4. Since these gases are electrical insulator, they prevent the good working of the electrolysis reaction and must be continuously evacuated outside of the casing 4.

For this purpose, the casing 4 includes a degassing unit 7 comprising a gas recovery part 8 extending longitudinally along the opposite side 27 of the anode plate 2 to the electrolyte chamber 6. This gas recovery part 8 is a compartment provided to be filled with the electrolyte 5 and disposed between the anode plate 2 and the cover plate 13. Said gas recovery part 8 is thus provided to recover gases escaping through the anode plate 2.

As depicted in FIG. 1, the degassing unit 7 also comprises an electrolyte recirculation part 28 extending in continuity with the gas recovery part 8 up to a gas outlet 29 managed in the casing 4. The electrolyte recirculation part 28 is provided to be at least partly filled with the electrolyte 5. In addition, said recirculation part 28 is in fluidic connection with the electrolyte chamber 6. When the apparatus 1 is operating, the recirculation part 28 allows the electrolyte 5 flowing from the gas recovery part 8 to be redirected towards the electrolyte chamber 6 via for example an elbow duct 30 of the electrolyte recirculation part 28 which is adjacent to the anode plate 2 and fluidically connected to the electrolyte chamber 6.

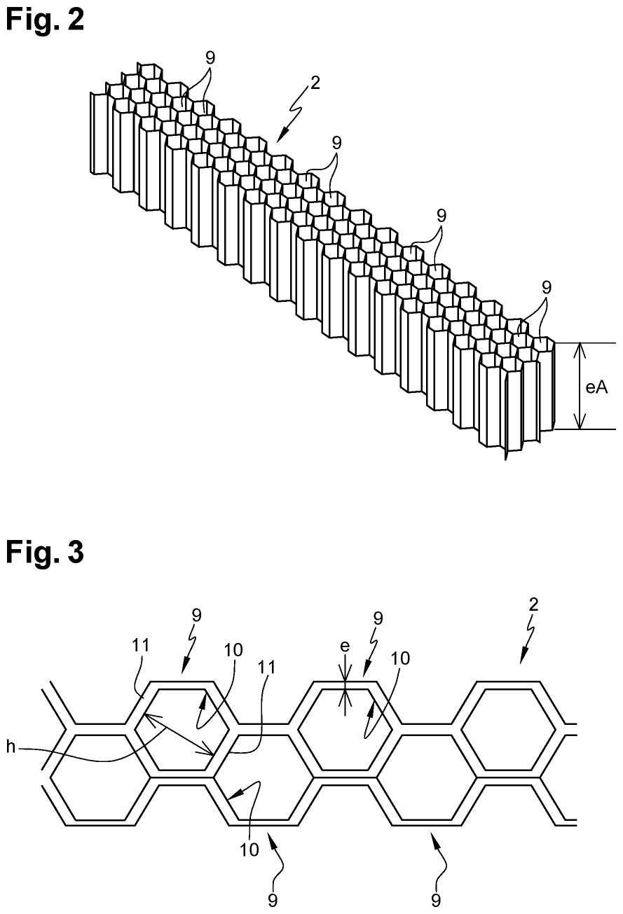

With reference to FIGS. 2 et 3 and according to the present disclosure, the gas permeable anode plate 2 is made of a cellular material comprising a plurality of cells 9. Each cell 9 is delimited by a circumferential wall 10 and opened on both opposite side of the anode plate 2, thus extending from the electrolyte chamber 6 to the gas recovery part 8 (see FIG. 1). Such configuration allows the gas bubbles to flow together with the electrolytes 5 through the anode plate 2 for the gas evacuation.

All cells preferably have the same height, and the anode has thus a constant thickness e_{A}. The thickness e_{A} of the anode is defined as the distance between the top and the bottom of the anode, the bottom side being the one facing the electrolyte chamber 6 while the top is the opposite side facing the gas recovery part 8. The thickness e_{A} of the anode is preferably from 5 to 50 mm, more preferably from 10 to 20 mm. This allows an improved gas evacuation while keeping a compact design of the apparatus.

In addition to its role for the evacuation of gas bubbles, the gas permeable anode plate 2 must contribute to an homogeneous electrolysis reaction to generate a uniform growth of the iron deposit. Moreover, the gas permeable anode plate 2 must be sufficiently robust to withstand environmental conditions, particularly to withstand continuous immersion into the electrolyte and continuous submission to an anodic current. Especially, the electrolyte may comprise caustic soda at a concentration of 50% and thin iron oxide particles (10-40 μm diameter). The temperature inside the casing may be from 100 to 130° C. The power supplied to the electrodes may be of 5 VDC for a current intensity of about 1000 A/m2.

To this end, the cellular material constituting the gas permeable anode plate 2 has preferably a honeycomb structure in which the cells 9 are regularly and periodically repeated on the anode plate 2 for both gas evacuation and uniformity of electrical conduction purposes. More precisely, each cell 9 has a hexagonal cross section and preferably each hexagon is an equilateral hexagon. Such configuration offers a perfect structural uniformity that increases the effective robustness of the anode plate and enhances the electrical performances. Furthermore, such configuration maximises the perimeter of each cell 9 for a better gas evacuation.

Moreover, two adjacent cells 9 of the cellular material are directly contiguous by sharing one common straight wall 11. Each cell 9 is therefore directly surrounded by six identical cells 9 except for the cells 9 located at the periphery of the anode plate 2. Such configuration allows to maximize the number of gas evacuation cells 9 while having a uniform thickness of metal for enhancing the electrical conduction. Such configuration also plays a role in the robustness of the anode plate since the forces to which the anode plate may be subjected are uniformly distributed over its entire surface.

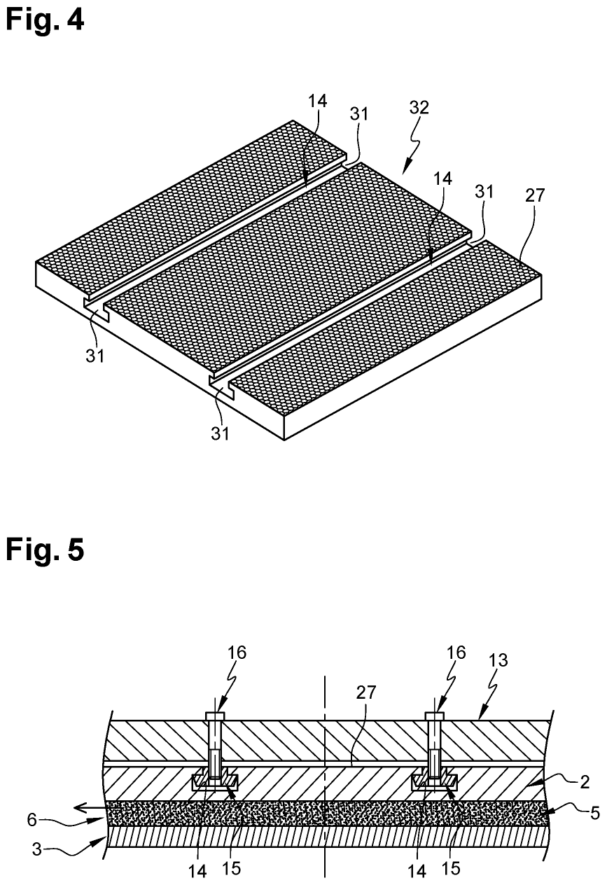

In the embodiments of FIGS. 4 and 5, the anode plate 2 is made of a plurality of blocks 32, each of them being a quadrilateral plate entirely made of the above-described cellular material. To form the anode plate 2 and to maintain each block 32 (and the resulting anode plate 2) at the required distance from the cathode plate 3 in the apparatus 1, fastening means are used which may include two T-shape grooves 14 managed in the thickness of the block 32 and extending transversally along the opposite side 27 of the block 32 to the electrolyte chamber 6.

As illustrated on FIG. 5, each T-shape groove 14 receives a T-shape rod 15 which is inserted into the corresponding T-shape groove 14 by sliding from one of its ends 31. When locked into the T-shape groove 14, the T-shape rod 15 cannot be extracted from the T-shape groove 14 from the top. Fastening means 16 cross the cover plate 13 along corresponding holes up to the T-shape rods 15. The block 32 is therefore securely held in the casing 4 at the required distance from the cathode plate 3. This operation is repeated for each block 32. The number of blocks 32 is adjusted by the person skilled in the art according to the required dimension of the anode plate 2.

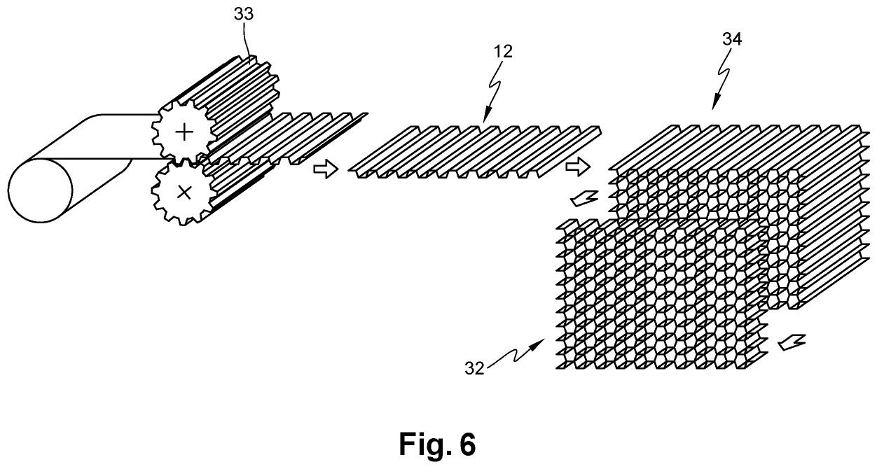

A manufacturing method of a block 32 is now described in reference to FIG. 6. First, a metallic sheet is pressed between toothed rollers 33. The resulting corrugated sheets 12 are welded together to form an initial block 34 which is cut by slice whose thickness corresponds to the desired thickness of the anode plate 2, thus providing blocks 32 ready to be assembled to form the anode plate 2 as previously described. T-shape grooves 14 may finally be machined to obtain the block 32 of FIG. 4 (not depicted on FIG. 6).

Such method implies robustness of the resulting anode plate while being easy to implement and cost effective.

The cellular material and therefore the resulting anode plate are advantageously made of nickel alloy, for example commercialised under the tradename Nickel®200 or Nickel®201.

In a preferred embodiment this electrical power source supplying the apparatus 1 uses renewable energy which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO2 to be produced. This further limit the CO2 footprint of the iron production process.

### EXAMPLE

Each block 32 is made of Nickel® 200 or Nickel®201. The cellular material is made of honeycomb structure as previously described. The thickness e of the hexagonal wall 10 of each cell 9 is of 0.25 mm and the distance h between two opposite parallel straight walls 11 of one cell 9 is of 3.175 mm. The ratio between the thickness e and the distance h being is therefore of 0.079.

The dimensions of each block 32 are as follows:
height: 20 mm+/−0.5 mm
width: 250 mm+/−0.5 mm
length: 250 mm+/−0.5 mm

Each block 32 is obtained with the previously described method as illustrated in FIG. 6.

The anode plate 2 is made of 44 blocks for a resulting surface of the anode plate 2 of 2.75 m².

The anode plate according to the present disclosure promotes good evacuation of the gases outside of the electrolyte chamber and therefore allows a good productivity of the electrolyte cell while being easily manufactured and cost effective.

What is claimed is:

1-12. (canceled)

13: An apparatus for producing iron through reduction of iron ore by an electrolysis reaction, the electrolysis reaction emitting a gas, the apparatus comprising:
a casing including a gas-permeable anode plate and a cathode plate on a first side of the gas-permeable anode plate, the gas-permeable anode plate and the cathode plate facing each other and being separated by an electrolyte chamber,
the casing being provided with means for circulating an electrolyte within the electrolyte chamber and with means to supply iron ore to the electrolyte chamber,
the casing further including a degassing unit comprising a gas recovery part extending along a second side of the gas-permeable anode plate to the electrolyte chamber and being able to recover gas from the electrolysis reaction escaping through the gas-permeable anode plate, the second side being opposite of the first side,
the gas-permeable anode plate being made of a cellular material comprising a plurality of cells extending from the electrolyte chamber to the gas recovery part, each cell being delimited by a circumferential wall and being open on the first and second sides of the gas-permeable anode plate.

14: The apparatus according to claim 13, wherein the cells are regularly and periodically repeated on the gas-permeable anode plate.

15: The apparatus according to claim 13, wherein the circumferential wall of each cell has a hexagonal cross section.

16: The apparatus according to claim 15, wherein two adjacent cells share one straight wall of their respective hexagonal circumferential wall.

17: The apparatus according to claim 15, wherein a hexagon formed by the hexagonal circumferential wall of each cell is an equilateral hexagon.

18: The apparatus according to claim 17, wherein the equilateral hexagon is defined according to the formula e/h<0.1, e being a thickness of the hexagonal circumferential wall and h being a distance between two opposite parallel straight walls of the hexagon.

19: The apparatus according to claim 13, wherein the cellular material forming the gas-permeable anode plate has a honeycomb structure.

20: The apparatus according to claim 15, wherein the cellular material of the gas-permeable anode plate is produced by welding a plurality of corrugated sheets to each other.

21: The apparatus according to claim 13, wherein the casing comprises a cover plate facing the gas-permeable anode plate, wherein the gas-permeable anode plate comprises at least one T-shape groove extending transversally along a second side of the gas-permeable anode plate to the electrolyte chamber and receiving a corresponding T-shape rod, and wherein fastening means cross the cover plate up to the T-shape rod thus maintaining the gas-permeable anode plate at a required distance from the cathode plate.

22: The apparatus according to claim 13, wherein the gas-permeable anode plate is made of nickel alloy.

23: The apparatus according to claim 13, wherein the apparatus is electrically supplied by renewable energy.

24: The apparatus according to claim 13, wherein the gas-permeable anode plate has a thickness e_{A} from 5 to 50 mm.
